(19) United States
(12) Patent Application Publication
(10) Pub. No.: US 2025/0150285 A1
(43) Pub. Date: May 8, 2025

(54) MANAGING PATCHING OF WRITE-LIMITED MEMORY WITH A HARDWARE SECURITY MODULE

(71) Applicant: Marvell Asia Pte. Ltd., Singapore (SG)

(72) Inventors: Tolga Aytek, Framingham, MA (US); Xin Mao, Sudbury, MA (US); Minda Zhang, Westford, MA (US)

(21) Appl. No.: 18/939,010

(22) Filed: Nov. 6, 2024

Related U.S. Application Data
(60) Provisional application No. 63/547,836, filed on Nov. 8, 2023.

(51) Int. Cl. H04L 9/32; G06F 8/65; H04L 9/08

(52) U.S. Cl. CPC H04L 9/3247; G06F 8/65; H04L 9/0861

(57) ABSTRACT

Managing patching of write-limited memory with a hardware security module (HSM) comprising a plurality of one-time programmable (OTP) memory blocks where each OTP memory block is associated with a respective identification value, comprises: receiving, from a patching entity, a patch management request, the patch management request comprising a first identification value associated with an OTP memory block of the plurality of OTP memory blocks of the HSM, an identity token, a cryptographic key, and a signature object; comparing, by the HSM, the identity token and the cryptographic key to a respective identity token and a respective cryptographic key stored in the HSM; verifying, by the HSM, the signature object of the patch management request; configuring a patch code; and installing the patch code in the write-limited memory.

### CROSS-REFERENCE TO RELATED APPLICATION(S)

This application claims priority to and the benefit of U.S. Provisional Application Ser. No. 63/547,836, entitled “Hardware Security Module (HSM) Protected Patching,” filed Nov. 8, 2023, the entire disclosure of which is incorporated herein by reference.

### TECHNICAL FIELD

This disclosure relates to managing patching of write-limited memory with a hardware security module.

### BACKGROUND

System architectures have increasingly been employed in an array of applications ranging from automotive systems, smart home automation, or industrial production line systems. In some implementations, a system architecture can control or enable program execution within a larger system to perform a broad range of functions. Some system architectures can facilitate complex operations such as real-time data processing, sensor integration, and automated decision-making. In some implementations, a system architecture can comprise one or more integrated circuits combined into a system-on-chip (SOC) device. Some integrated circuits can comprise components such transistors, resistors, and capacitors. Some SOCs can comprise hardware security modules (HSMs). Some HSMs are hardened, tamper-resistant hardware devices that secure cryptographic processes by generating, protecting, and managing keys used for encrypting and decrypting data and creating digital signatures and certificates.

### SUMMARY

In one aspect, in general, a method for managing patching of write-limited memory with a hardware security module (HSM) comprising a plurality of one-time programmable (OTP) memory blocks where each OTP memory block is associated with a respective identification value, comprises: receiving, from a patching entity, a patch management request, the patch management request comprising a first identification value associated with an OTP memory block of the plurality of OTP memory blocks of the HSM, an identity token, a cryptographic key, and a signature object; comparing, by the HSM, the identity token and the cryptographic key to a respective identity token and a respective cryptographic key stored in the HSM; verifying, by the HSM, the signature object of the patch management request; configuring a patch code; and installing the patch code in the write-limited memory.

Aspects can include one or more of the following features.

The method further comprises deactivating the OTP memory block associated with the first identification value.

The configuring the patch code further comprises checking the patch code for errors and loading the patch code into random access memory (RAM) of the HSM.

The patch code is loaded from an OTP memory block of the HSM associated with a third identification value into RAM of the HSM.

The method further comprises activating the OTP memory block associated with the second identification value.

The second identification value is determined based at least in part on a comparison of a size of the patch code and a size of the OTP memory block associated with the second identification value.

The patch management request further comprises the patch code.

In another aspect, in general, a method for managing patching of write-limited memory of a system architecture manufactured by a first entity, wherein the system architecture comprises a hardware security module, comprises: generating, by a second entity that is different from the first entity, a cryptographic key associated with the system architecture; storing the cryptographic key associated with the system architecture in the hardware security module of the system architecture; configuring, by the first entity, a patch code associated with the write-limited memory of the system architecture; generating, by the second entity, a patch management request associated with a signature object, wherein the signature object is produced at least in part on the cryptographic key associated with the system architecture; and providing the patch management request to the system architecture.

Aspects can include one or more of the following features.

The write-limited memory of the system architecture comprises one or more one-time programmable fuses.

The method further comprises verifying the signature object of the patch management request based at least in part on a comparison of the signature object and the cryptographic key associated with the system architecture.

The verifying the signature object of the patch management request is performed by the hardware security module.

The method further comprises deactivating one or more blocks of the write limited memory based at least in part on the patch management request.

The hardware security module comprises at least a portion of the write-limited memory.

The patch management request comprises the patch code.

In another aspect, in general, an apparatus comprises: write-limited memory; a hardware security module (HSM) comprising a memory module comprising a plurality of one-time programmable (OTP) memory blocks where each OTP memory block is associated with a respective identification value; and processor circuitry configured for managing patching of the write-limited memory, the managing comprising receiving, from a patching entity, a patch management request, the patch management request comprising a first identification value associated with an OTP memory block of the plurality of OTP memory blocks of the HSM, an identity token, a cryptographic key, and a signature object, comparing, by the HSM, the identity token and the cryptographic key to a respective identity token and a respective cryptographic key stored in the HSM, verifying, by the HSM, the signature object of the patch management request, configuring a patch code, and installing the patch code in the write-limited memory.

Aspects can include one or more of the following features.

The write-limited memory comprises one or more OTP fuses.

The hardware security module comprises at least a portion of the write-limited memory.

In another aspect, in general, an apparatus comprises: write-limited memory; a hardware security module (HSM) comprising a memory module comprising a plurality of one-time programmable (OTP) memory blocks where each OTP memory block is associated with a respective identification value; and means for managing patching of the write-limited memory, the managing comprising receiving, from a patching entity, a patch management request, the patch management request comprising a first identification value associated with an OTP memory block of the plurality of OTP memory blocks of the HSM, an identity token, a cryptographic key, and a signature object, comparing, by the HSM, the identity token and the cryptographic key to a respective identity token and a respective cryptographic key stored in the HSM, verifying, by the HSM, the signature object of the patch management request, configuring a patch code, and installing the patch code in the write-limited memory.

Aspects can include one or more of the following features.

The write-limited memory comprises one or more OTP fuses.

The hardware security module comprises at least a portion of the write-limited memory.

Aspects can have one or more of the following advantages.

In some implementations, the methods and systems disclosed herein can be utilized to perform secure patching of write-limited memory associated with a system architecture. In some implementations, the secure patching can be performed by authorized users of an SOC.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an example method for patching write-limited memory.

FIG. 2 is a schematic diagram of an example method for patching write-limited memory.

FIG. 3 is a schematic diagram of an example implementation for OTP patch control.

FIG. 4 is a schematic diagram of an example method of patching write-limited memory.

### DETAILED DESCRIPTION

Some SOCs can comprise write-limited memory that has limitations on the types of operations that can be used to write to such memory. Some forms of such write-limited memory are referred to as read-only memory (ROM) that can store firmware that physically cannot be modified by typical memory writing operations, which may require special operations to write or erase and re-write the contents of such memory. In some examples, ROM can be electrically erasable programmable read-only memory (EEPROM). Due to the tamper proof nature of some forms of ROM, an SOC can utilize ROM to store a root-of-trust initial boot sequence and/or to retain critical security code such that the code can remain in isolation. In such implementations, the ROM can be referred to as BootROM. If a bug or issue is discovered once some content is physically committed to the ROM, fixing the bug or issue can be very expensive and traditionally can require a chip layer re-spin. In some implementations, patching content such as code can be utilized to fix a bug or issue with ROM. In some implementations, an HSM associated with an SOC can be utilized to protect and manage ROM patching content such that the patching content can only be applied by authorized users of the SOC.

Some HSMs can comprise a plurality of one-time programmable (OTP) bits. Some OTP bits comprise fuses that are configured to be programmed once by shorting a gate and source of a transistor to create a permanent data state associated with the OTP bit. In some implementations, placing OTP content within an HSM can provide additional protection and direct management since the same concepts that apply to managing keys in OTP can be applied. In some implementations, OTP patch blocks or OTP memory blocks can be created by partitioning the plurality of OTP bits.

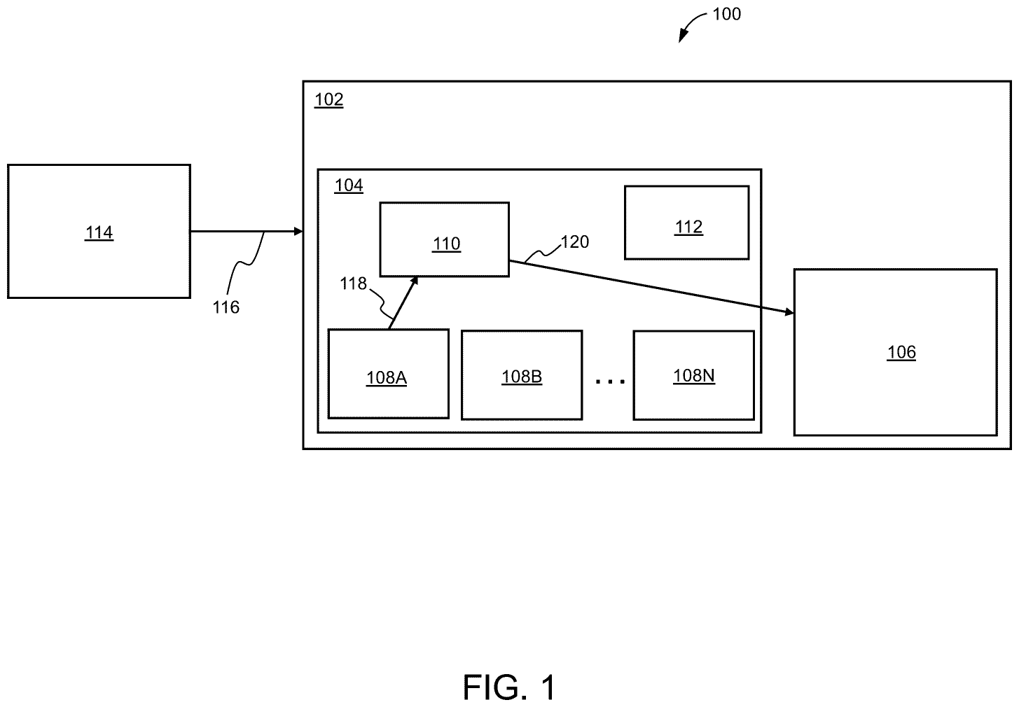

FIG. 1 depicts an example implementation 100 for managing patching of ROM 106 of an example SOC 102. The SOC 102 comprises an HSM 104 and ROM 106. The HSM 104 comprises a plurality of OTP memory blocks 108A-108N, where each OTP memory block 108A-108N is associated with a respective identification value (not shown). The HSM 104 also comprises RAM 110 and memory 112. The SOC 102 receives a patch management request 116 from a patching entity 114. The patch management request 116 comprises a first identification value associated with an OTP memory block 108A-108N, an identity token, a cryptographic key, and a signature object. The HSM 104 compares the identity token and the cryptographic key to a respective identity token and a respective cryptographic key stored in the memory 112. The HSM 104 also verifies the signature object of the patch management request. Patch code is then configured and installed on the ROM 106. In some implementations, the patch code can be installed in an OTP memory bank 108A and loaded 118 into the RAM 110 for testing. The patch code can then be installed 120 in the ROM 106.

In some implementations, an SOC can comprise processor circuitry comprising processor cores configured to manage patching of ROM. In some examples, an HSM can comprise one or more processor cores. In some implementations, one or more processor cores can be located outside an HSM. Some SOCs can be configured to have one or more processor cores in an HSM and one or more processor cores outside of an HSM.

In some implementations, an HSM can comprise instruction ROM (iROM) that can be patched using a similar method to the method depicted in FIG. 1. In some implementations, an HSM can comprise OTP memory blocks for patching the iROM or BootROM associated with the SOC.

In some implementations, each OTP memory block can by protected by Error Correction Code (ECC). In some implementations, each OTP memory block can have associated partition management control signals. Some partition management control signals can comprise deactivation control to allow individual enabling or disabling of patch blocks. Some partition management control signals can comprise patching buffer assignment to allow an HSM to direct memory access (DMA) patch content of enable blocks to a specified SOC buffer address in contiguous order. In some implementations managing ROM patching can comprise pre-assigning a system memory buffer to allow an HSM to output all the OTP-provisioned ROM patching code images to the system memory buffer via HSM direct memory access (DMA) controller upon each SoC reset. A SoC BootROM can apply the ROM patch code image from this system memory buffer to a ROM code image and then can execute the patched ROM code.

In some implementations, HSM primitives can be provided to facilitate the loading of patches. Patches may be installed or revoked at any time including, in the field, by setting a Patching Buffer Address for BootROM. In some implementations, managing patches can be done when the device is in the Provision Life Cycle. Some examples of HSM primitives can be found below:

HSM_BootROM_Patch_Address—Specifies a 64-bit system physical address that will be used to move all BootROM related OTP patch blocks by using the HSM DMA. The BootROM can then copy itself to local RAM, pick up the patch content from the Buffer Address and overwrite applicable areas in local RAM. Patch content can then execute from local RAM. In some implementations, this primitive can only be satisfied if an HSM life cycle is in the PROVISION state.

HSM_BootROM_Patch_Provision—This primitive can be used to program the next available BootROM OTP block(s) in sequence with the patch material specified. Once programmed, the HSM can generate the ECC for the programmed blocks, program the ECC to OTP and set the active control bits for the programmed blocks. In some implementations, this primitive can only be used for OTP blocks that have previously been un-programmed.

HSM_IROM_Patch_Provision—This primitive can be used to program the next available iROM OTP block(s) in sequence with the patch material specified. Once programmed, the HSM can generate the ECC for the programmed blocks, program the ECC to OTP, and set the active control bits for the programmed blocks. In some implementations, this primitive can only be used for OTP blocks that have previously been un-programmed.

In some implementations, a patch installation can be guarded using existing HSM authentication principles before allowing patching to move forward. In some implementations, a device can be configured to have one or more boot states, wherein each boot state is associated with different security permissions. In some implementations, authentication can include one or more of the following steps. (1) A device can be at least in the PRIVISION State and Secure Boot/Encrypted Boot/Measured Boot can be locked. (2) Validation of the input token and public key against an unrevoked Key Authentication Key (KAK) that is currently provisioned in the HSM. (3) Verification of the digital signature with the selected unrevoked KAK public key of the request packet that includes the primitive type. (4) Checking for available free OTP blocks for BootROM or iROM based on the size of the input patch content.

In some implementations, managing patching can be associated with resetting an SOC to boot a device into a different boot state. In some implementations, after SOC reset, an HSM can provide two status bits through shadow registers configured to hold data to be used later. These status bits can indicate the readiness of the patching code for the BootROM which may be “Loading”, “Ready” and “No Patch”. If patching code exists, an HSM can perform ECC over the programmed blocks and DMA the content to the address programmed in the Patching Buffer Address. An HSM can then set the Ready status bit. In some implementations, a target SOC BootROM can wait for the “Ready” bits to be set when the “Loading” bits is are set before proceeding to apply the patch. In some examples, if there are no BootROM patch blocks programmed, then the target BootROM will not wait for a patch as the status bits will indicate “No Patch”.

In some implementations, one or more OTP memory blocks of an HSM can be pre-programmed with patching code. In some examples, if any of the dedicated OTP patching blocks for the eHSM have been programmed, an HSM can ECC over the activated patching blocks and if no uncorrectable errors are found, an HSM can copy the patch blocks into private dedicated static random-access memory (SRAM). The patch material can then selectively override functions or variables by modifying the respective function pointers or variable pointers in the function or variable descriptors.

Without using the methods disclosed herein, some examples of conventional ROM patching can be managed by an entity such as the silicon company that manufactured the SoC. In such examples, an authentication key can be hard-coded within silicon resistor-transistor logica (RTL) circuitry. As a result, all OEM/ODM can have the same key for ROM code patching authentication key. This key similarity can become an issue in terms of liability management once the device has been deployed to end market.

In contrast, in utilizing the methods disclosed herein, an original equipment manufacturer (OEM), original device manufacturer (ODM), or the owner of the device powered by a SoC that is manufactured by a different entity, can provision its own authentication key. This provisioning can allow a device owner to own the authentication key and assume responsibility to manage the ROM code patching by allowing the device owner to provision the device to be ROM patchable or ROM dispatchable. In some examples, the provisioning of a device owner's authentication key can occur while a device is in a PROVISION state. In some examples, this PROVISION state can be associated with the device manufacturing process. Following the manufacturing process, a device can be advanced to a DEPLOY state. In some implementations, To be secure and reliable, some devices may not allow provisioning of a device owner's authentication key.

In some examples, for a ROM patchable device, each ROM patching code can be digitally signed with the device owner's signing key. In some examples, a device owner can also be responsible to manage revoking some provisioned ROM patch code with a security weakness. In some implementations, using an HSM can support the revoking of privileges associated with the ROM patch code with a security weakness through authentication.

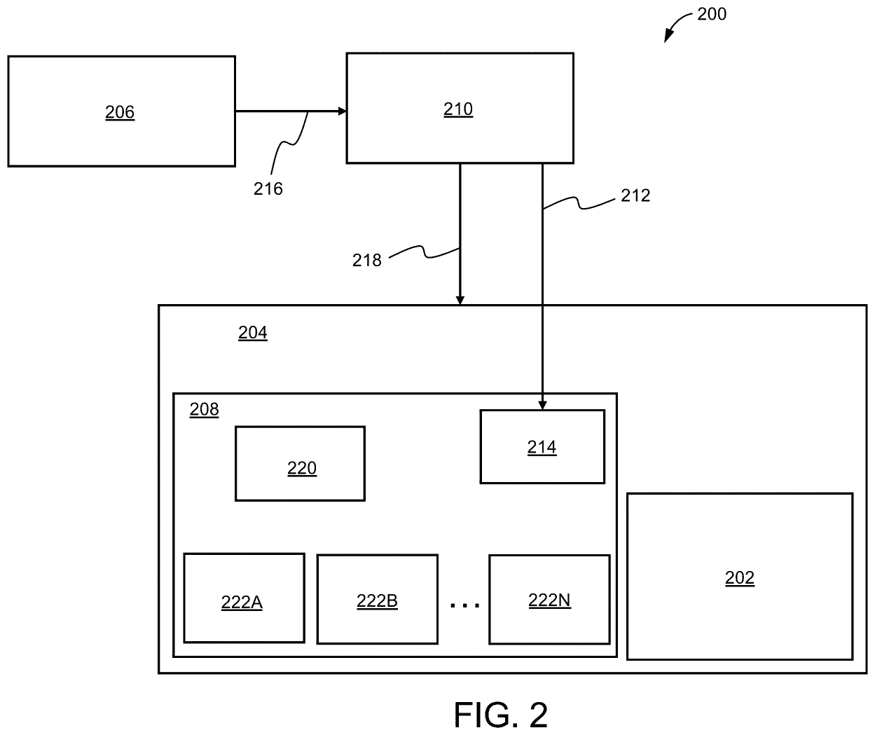

FIG. 2 depicts an example implementation 200 for managing patching of read-only memory 202 of a system architecture 204 manufactured by a first entity 206. The system architecture 204 comprises an HSM 208. A second entity 210 generates 212 a cryptographic key associated with the system architecture 204 and stores the cryptographic key in a key slot 214 in the HSM 208. The first entity 206 configures patch code 216 for the read-only memory 202. The second entity 210 generates a patch management request (not shown) associated with a signature object, wherein the signature object is produced at least in part on the cryptographic key. The patch management request is then provided 218 to the system architecture. In some examples, the HSM 208 can also comprise RAM 220 and a plurality of OTP memory blocks 222A-222N.

In some implementations, using an HSM for patching can allow for securely enabling/disabling OTP patch blocks while the device is deployed in the field. In some examples, an HSM can utilize existing authenticated commands that are challenge and response based to verify a requesting party. Examples of authenticated commands can be found below:

HSM_BootROM_Patch_Revocate—This authenticated command can used to de-activate a patch based on specified OTP block number. In some examples, an OTP block can be in the active state. After successful verification of the request, the respective block number in the BootROM portion of the patch management area can be marked as deactivated and this block can no longer be used in the life of the SOC for patching.

HSM_iROM_Patch_Revocate—This authenticated command can be used to de-activate a patch based on specified OTP block number. In some examples, the OTP block can be in the active state. After successful verification of the request, the respective block number in the IROM portion of the patch management area can be marked as deactivated and this block can no longer be used in the life of the SOC for patching.

In some examples, authenticated commands can be configured in one or more of the following ways to formulate a challenge response: (1) Global Challenge: This value may be provisioned across a subset of devices. (2) Universally unique identifier (UUID): Unique ID that is chip specific. (3) Random Number generated through a deterministic random bit generator (DRBG) intellectual property (IP) module.

In some implementations, a patch management request can comprise one or more of the following data: (1) HSM_BootROM_Patch_Revocate/HSM_iROM_Patch_Revocate command ID. (2) Challenge: Global/UUID/Random Number. (3) Starting OTP Block Number to de-activate. (4) Ending OTP Block Number to de-activate (may be the same). (5) Token. (6) Public Key. (7) Digital Signature.

In some examples, an HSM can validate the input token and public key against an unrevoked Key Authentication Key (KAK) that is currently provisioned in the HSM. An HSM can then verify the digital signature with the selected unrevoked KAK public key found in the command package. In some examples, if these checks pass and the specified OTP blocks are in the active state, an HSM can proceed to deactivate them.

In some implementations, a token can be implemented to establish an enhanced multi-factor authentication mechanism to manage the ROM patch binary images within an HSM electronic fuse (eFUSE) macro. In some implementations, a public key can be generated by implementing an algorithm or technique such as Rivest-Shamir-Adleman (RSA) or elliptic curve cryptography. Public key cryptography can also be referred to as asymmetric cryptography, as anyone can encrypt data using a public key, but the holder of a paired private key can decrypt the data. In some implementations, a public key can be provisioned in an HSM eFUSE macro to be used for verifying the digital signatures of the ROM patch binary images as well as the document for authorizing the revoking or invalidating some already-provisioned ROM patch code binaries. In some implementations, a digital signature can be generated using an algorithm such as Digital Signature Standard. Some digital signatures can provide authentication of the identity of a data sender and/or ensure that content has not been modified since signing. In some examples, a hash function can also be utilized.

In some implementations, other features can be included to enhance robustness associated with ROM patching. For instance, an HSM can provide a Soft-OTP burning mechanism and/or a cyclic redundancy code (CRC) protection mechanism. Some examples of soft-OTP memory can only retain contents across a reset but not a cold power-on. The device owner can use soft-OTP burning mechanism to provision a candidate of the ROM patching code, and after soft-reset SOC, the ROM code will apply the ROM patching code and test if the newly patched code functions. Some examples of soft OTP can mimic a real OTP except that patch content is not committed to the device such that a reset can discard data in the soft-OTP. Some examples of soft-OTP can behave like real OTP when initially programmed, allowing testing of the validity and applications of the patch before programming or committing to the real OTP. If the patched code is not fully functioning, then a device owner can discard the ROM patching code. Only after tested ROM pathing, device owner can call HSM primitives to commit what has been provisioned in the soft-OTP into an OTP macro that programs OTP bits and makes the patch code permanent.

In some implementations, a CRC checking mechanism can allow for ROM patching to be flowless before starting using a ROM patch for platform boot. In some examples, if a CRC checking fails, an HSM can be put into safe-state by code from BootROM or iROM. Some implementations of safe-state by support a secure boot to a device owner's bootloader firmware (FW). A bootloader FW can then conduct a ROM patching revoking authentication protocol for managing the ROM patching code provisioned within the eHSM eFUSE OTP macro. In some implementations, this protocol can avoid a device hang state associated with corruptions or violations from an improper patch.

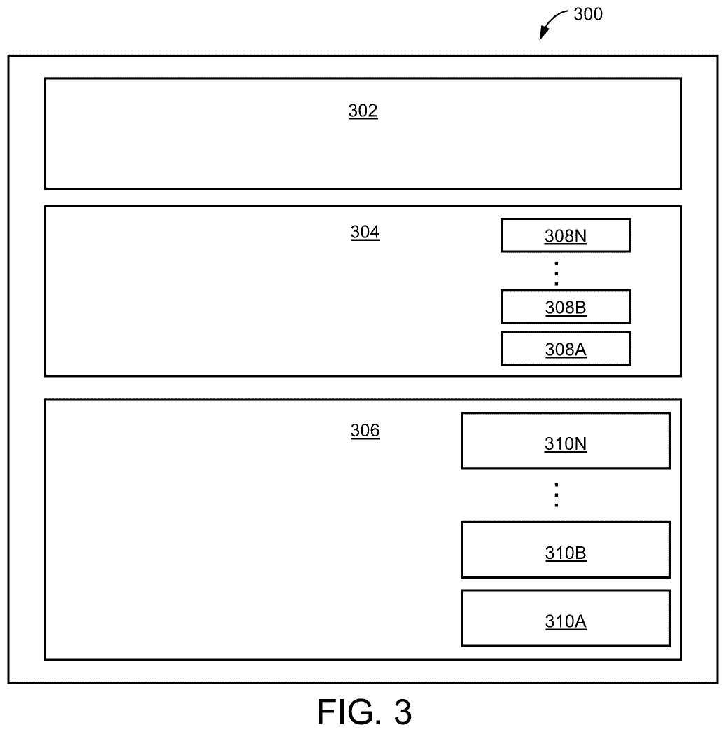

FIG. 3 depicts an example implementation 300 that can be included in an HSM module for OTP patch control. The implementation 300 comprises patching management 302, ECC area 304, and patch code area 306. In some implementations, the patching management 302 can comprise deactivation control and patching buffer address. Some examples of patching management 302 can support provision or revocation authentication. The ECC area 304 comprises a plurality of ECC blocks 308A-308N. The patch code area 306 comprises a plurality of OTP memory blocks 310A-310N. Each OTP memory block 310A-310N is associated with a different respective ECC block 308A-308N.

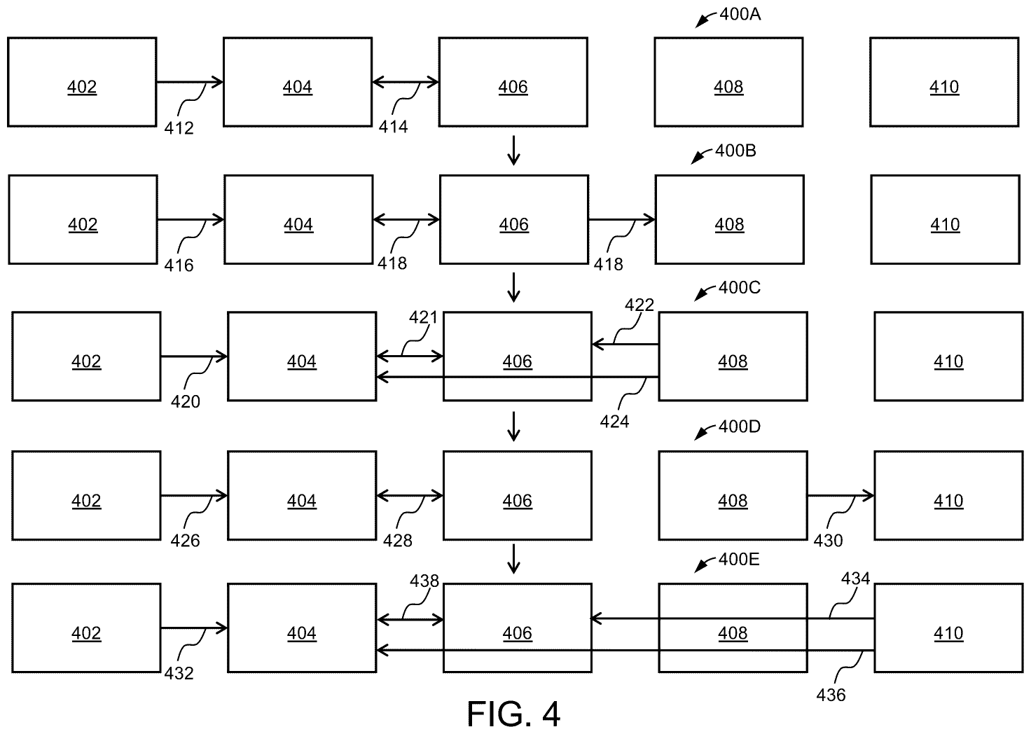

FIG. 4 depicts an example method comprising steps 400A-400E associated with patching a device. The method comprises a cold boot step 400A, a patch provisioning step 400B, a reset and test phase step 400C, a patch commit step 400D, and a reset and boot step 400E. The device comprises boot media 402, a boot CPU core 404, an HSM 406, RAM 408, and OTP fuses 410. The cold boot step 400A comprises providing 412 a patched provisioning image (PPI) from boot media 402 to the boot CPU core 404, on which bootROM is running. In some examples, the patched provisioning image can be verified against a digital signature within the trusted image module (TIM) using the HSM 406. The HSM performs 414 secure boot authentication. The patch provisioning step 400B comprises providing 416 a signed patch file from the boot media 402 to the boot CPU core 404, on which the PPI is running. The HSM loads and provisions 418 the signed patch file from the boot CPU core 404 to the RAM 408. The reset and test phase step 400C comprises providing 420 PPI from the boot media 402 to the boot CPU core 404, on which bootROM is running. The HSM 406 can send (422 or 424) the patch from the RAM 408 to either the HSM 406 (if the patch is for HSM iROM) or to the boot CPU core 404 (if the patch is for bootROM). The HSM 406 performs 421 secure boot authentication. The patch commit step 400D comprises providing a signed patch file 426 from the boot media to the boot CPU core 404, on which PPI is running. The HSM 406 gets 428 the patch from the boot CPU core 404 and commits 430 the patches from the RAM 408 to the OTP fuses 410. The reset and boot step 400E comprises providing 432 a boot loader from the boot media 402 to the boot CPU core 404. The HSM 406 applies 434 or 436 the patch from the OTP fuses 410 to either the HSM 406 (if the patch is for HSM iROM) or to the boot CPU core 404 (if the patch is for bootROM). The HSM 406 performs 438 secure boot authentication.

In some implementations, a PPI can be a binary that executes on the SOC core and performs the communication with an HSM to properly push patches.

In some implementations, a TIM is a binary header that contains information on how to boot. Some TIMs are not an executable and do not contain machine instructions. A TIM can also contain public component of keys used for secure boot and patching. In some examples, the body of a TIM can be covered by a Digital Signature. In some examples, a TIM can also contain hashes of other images used in the secure boot process.

In some implementations, an HSM can allow two 8K of OTP bits is dedicated for patching HSM iROM and SOC BootROM. In some examples, the blocks of OTP bits can be further partitioned in to 256-bit OTP patch blocks that individually protected by 18-bit ECC.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for managing patching of write-limited memory with a hardware security module (HSM) comprising a plurality of one-time programmable (OTP) memory blocks where each OTP memory block is associated with a respective identification value, the method comprising:
receiving, from a patching entity, a patch management request, the patch management request comprising a first identification value associated with an OTP memory block of the plurality of OTP memory blocks of the HSM, an identity token, a cryptographic key, and a signature object;
comparing, by the HSM, the identity token and the cryptographic key to a respective identity token and a respective cryptographic key stored in the HSM;
verifying, by the HSM, the signature object of the patch management request;
configuring a patch code; and
installing the patch code in the write-limited memory.

2. The method of claim 1, further comprising deactivating the OTP memory block associated with the first identification value.

3. The method of claim 1, wherein the configuring the patch code further comprises checking the patch code for errors and loading the patch code into random access memory (RAM) of the HSM.

4. The method of claim 3, wherein the patch code is loaded from an OTP memory block of the HSM associated with a third identification value into RAM of the HSM.

5. The method of claim 1, further comprising activating the OTP memory block associated with the second identification value.

6. The method of claim 1, wherein the second identification value is determined based at least in part on a comparison of a size of the patch code and a size of the OTP memory block associated with the second identification value.

7. The method of claim 1, wherein the patch management request further comprises the patch code.

8. A method for managing patching of write-limited memory of a system architecture manufactured by a first entity, wherein the system architecture comprises a hardware security module, the method comprising:
generating, by a second entity that is different from the first entity, a cryptographic key associated with the system architecture;
storing the cryptographic key associated with the system architecture in the hardware security module of the system architecture;
configuring, by the first entity, a patch code associated with the write-limited memory of the system architecture;
generating, by the second entity, a patch management request associated with a signature object, wherein the signature object is produced at least in part on the cryptographic key associated with the system architecture; and
providing the patch management request to the system architecture.

9. The method of claim 8, wherein the write-limited memory of the system architecture comprises one or more one-time programmable fuses.

10. The method of claim 8, further comprising verifying the signature object of the patch management request based at least in part on a comparison of the signature object and the cryptographic key associated with the system architecture.

11. The method of claim 10, wherein the verifying the signature object of the patch management request is performed by the hardware security module.

12. The method of claim 8, further comprising deactivating one or more blocks of the write limited memory based at least in part on the patch management request.

13. The method of claim 8, wherein the hardware security module comprises at least a portion of the write-limited memory.

14. The method of claim 8, wherein the patch management request comprises the patch code.

15. An apparatus comprising:
write-limited memory;
a hardware security module (HSM) comprising
a memory module comprising a plurality of one-time programmable (OTP) memory blocks where each OTP memory block is associated with a respective identification value; and
processor circuitry configured for managing patching of the write-limited memory, the managing comprising
receiving, from a patching entity, a patch management request, the patch management request comprising a first identification value associated with an OTP memory block of the plurality of OTP memory blocks of the HSM, an identity token, a cryptographic key, and a signature object,
comparing, by the HSM, the identity token and the cryptographic key to a respective identity token and a respective cryptographic key stored in the HSM,
verifying, by the HSM, the signature object of the patch management request,
configuring a patch code, and
installing the patch code in the write-limited memory.

16. The apparatus of claim 15, wherein the write-limited memory comprises one or more OTP fuses.

17. The apparatus of claim 15, wherein the hardware security module comprises at least a portion of the write-limited memory.

18. An apparatus comprising:
write-limited memory;
a hardware security module (HSM) comprising
a memory module comprising a plurality of one-time programmable (OTP) memory blocks where each OTP memory block is associated with a respective identification value; and
means for managing patching of the write-limited memory, the managing comprising
receiving, from a patching entity, a patch management request, the patch management request comprising a first identification value associated with an OTP memory block of the plurality of OTP memory blocks of the HSM, an identity token, a cryptographic key, and a signature object,
comparing, by the HSM, the identity token and the cryptographic key to a respective identity token and a respective cryptographic key stored in the HSM,
verifying, by the HSM, the signature object of the patch management request,
configuring a patch code, and
installing the patch code in the write-limited memory.

19. The apparatus of claim 18, wherein the write-limited memory comprises one or more OTP fuses.

20. The apparatus of claim 18, wherein the hardware security module comprises at least a portion of the write-limited memory.
